(19) United States
(12) Patent Application Publication
(10) Pub. No.: US 2017/0097249 A1
(43) Pub. Date: Apr. 6, 2017

(54) SENSOR AND CABLE WITH LOCAL WIRELESS READ AND WRITE CAPABILITY AND METHODS OF USING SAME

(71) Applicant: MEGGITT (ORANGE COUNTY), INC., IRVINE, CA (US)

(72) Inventors: ANDREW EDWARD HOHLA, Mission Viejo, CA (US); JONATHAN LEE GEISHEIMER, Mission Viejo, CA (US); TERRY ALAN WEED, Mission Viejo, CA (US)

(21) Appl. No.: 15/192,678

(22) Filed: Jun. 24, 2016

Related U.S. Application Data
(60) Provisional application No. 62/184,180, filed on Jun. 24, 2015.

(51) Int. Cl. G01D 18/00; G01D 5/02

(52) U.S. Cl. CPC G01D 18/00; G01D 5/02; H04M 2250/10; H04W 88/02

(57) ABSTRACT

Methods and apparatus for verifying a transducer are provided. In preferred embodiments, the flow of current on a wire that provides power to both a micro-processor and a transducer is reversed. A wireless communication chip listens for and receives a read request and communicates the read request to a microprocessor. The microprocessor reads the transducer data from non-volatile memory and transmits it with the wireless chip. Preferably, a hand held device is used to initiate the transfer of and receive the transducer data.

### CROSS-REFERENCE TO RELATED APPLICATION

This application claims the benefit of U.S. Provisional Application No. 62/184,180, filed on Jun. 24, 2015, which is hereby incorporated by reference in its entirety.

### FIELD

The present patent document relates generally to cables and/or sensors with a wireless communication device incorporated therein to indicate the status, location, information and/or health of a connected component. The present patent document further relates to software implementations of a connection indicator, and more particularly to interconnection verification and physical location identification between cabling and sensors in multi-channel test and data acquisition configurations.

### BACKGROUND

There are costly and challenging methods of identifying and documenting data such as data pertaining to the location between cabling and a plurality of devices, including but not limited to sensors and the like. Dynamic sensors are transducers that are used to measure dynamic motion or force. Transducers exist in a large variety of shapes and forms, but virtually all consist of two general components: 1) a mechanical structure designed such that the applied motion or force input causes an internal deflection proportional to that input; and 2) an electrical element that measures that deflection such that the electrical output of the sensor is proportional to the magnitude of the deflection. The transduction from deflection to an electrical parameter defines the generic term “transducers” for such devices.

The form of electrical output of a dynamic sensor can vary to include virtually any parameter that is electrically measurable. A common measurement is charge, which is the number of electrons displaced by a dynamic event. However, the measurement might also be the voltage i.e., the electric field strength that caused those electrons to be displaced; the capacitance i.e., the ratio of charge to voltage; the current i.e., the rate of electron flow; the impedance or resistance i.e., the ratio of voltage to current, and so on.

As a non-limiting example, the basic design of a transducer consists of a thin plate of piezoelectric (“PE”) material clamped between a base and a mass. The mass serves as the inertial component. When the mounting surface that the base is attached to is accelerated, the inertial mass is also accelerated and results in a force that causes the PE material to deform. This PE property induces electrons to gather on one side of the plate. Electrodes attached to the appropriate surfaces of the plate lead to the electrical cable of the transducer, which communicates the induced electrical variance.

One problem that needs to be overcome in the design of transducers is the shielding from unwanted electrons that can be induced from myriad of external sources. For example, unwanted electrons may be manufactured from external electrical fields or from the rubbing of insulators in the electrical wires delivering the output to the data acquisition system. In order to overcome this problem, it is possible to use specialized electronics and shielding techniques to reduce the errors caused by such external noise sources. One technique is using a circuit to perform an impedance conversion, internal to the sensor, which translates the quantity of electrons to a voltage level. Once the appropriate voltage is determined, the circuitry floods the output with sufficient electrons, increases the current to maintain the voltage level while making the undesirable electrons induced by external sources insignificant. This circuitry may be referred to as an amplifier. These sensors along with their amplifier circuits are made by multiple manufacturers under many trademarks (e.g. ICP®, ISOTRON®, DELTATRON®), but can all be grouped under the term Integral Electronic Piezo Electric (“IEPE”).

The IEPE may be used in numerous different arenas. For example, the IEPE can be used in the industrial, environmental, military, aviation, and space vehicle fields. It can also be used for device monitoring, environmental monitoring, measuring experiments, seismic monitoring, conditional based machinery monitoring, vibration based alarming, shock detection, intruder deflection, infrastructure monitoring, and loose part detection, to name a few.

IEPE devices use two wires for their output. The first wire is the actual output which carries the additional current and the second wire is ground. The source of power for an IEPE device is a constant current thus, the output of the IEPE device, which represents the time-varying dynamic input to the transducer, takes the form of an analogously time-varying voltage. The time varying voltage component is in addition to the static voltage operating point of the IEPE circuit. The IEPE circuitry design has been extensively used in the industry for a number of reasons including its advantages in reduced noise, reduced cable costs, simplicity of associated external conditioning, and so on.

One characteristic of IEPE devices is that the static voltage operating point does not vary analogously to the parameter to be measured, even if that parameter has significant static value. The output of interest for IEPE devices is the alternating current (AC) (time varying) voltage signal riding on top of the static or “DC” operating point. The AC portion of the output signal does vary analogously with the input being measured.

Regardless of the type of transducer or its output signal, more often than not, numerous transducers may be used to monitor the performance, status or condition of a simple or complex structure or piece of equipment. Sometimes hundreds or even thousands of transducers may be used. Each transducer must be properly electrically connected to the equipment sensing the signal and in many cases, the location of the transducer must be identified and documented. The sensing equipment may be located far away, and each sensor may be connected through a cable with tens or hundreds of wires located in many places. In many cases, identifying the location of the transducer is highly critical and can be very costly if the incorrect location is documented for one or more transducers.

In addition, there is a need to reduce the manpower and the time that it takes to input the physical location of the transducers into the equipment sensing the signal. Current technology requires that the channel number be verified and then the location of the transducer must be manually input into the equipment sensing the signal. This process typically takes two people to conduct the process or if a TEDS capable transducer or a digital transducer is being used, then typically, only one person is required. However, that one person must disconnect the cable from the digital or TEDS transducer and attach a separate device to manually input the TEDS data that identifies the location of the transducer.

Others have implemented systems to try and address some of these issues. However, their implementations fall short for numerous reasons. One such attempt uses a barcode system to read the sensor serial number by putting bar code stickers on the sensors. Such barcode systems are tedious and still require excess man power. Other solutions include implementing a manual system and manually entering data into a database.

Accordingly, there is a need to provide a mechanism for verifying the connections of multiple channels coming from a multiplicity of locations so that an operator can be assured that the transducer showing the measured reading is in fact the transducer located in the physical location he believes it to be. There is a further need to ease the interconnection verification between a plurality of cables and a plurality of transducers. In addition, there is a need to provide for a low cost mechanism to couple a plurality of channels coming into a matrix of locations. There is also a need to be able to identify the locations of the transducers automatically without the use of a human manually inputting the locations thereby reducing or eliminating human error. There is also a need to create a verification mechanism that is simple to use thereby reducing the required skill level of the human operator(s) thereby reducing the need for higher cost, higher skilled labor.

### SUMMARY OF THE EMBODIMENTS

An object of the present patent document is to provide an improved location identifier for a plurality of transducers. To this end, in one embodiment, a device for interconnection verification is provided that comprises an ability to wirelessly transmit data about a transducer. Such embodiments may be incorporated in large test facilities that have a plurality of cables coupled to a plurality of locations. In preferred embodiments, a visual indicator is also added.

Another object of the present patent document is to provide an interconnection verification between cabling and transducers in multi-channel test configurations. A further object of the present patent document is to provide a means to ease interconnection verification between a receiving amplifier and its associated IEPE transducer in multi-channel test configurations using the existing 2-wire IEPE cabling interface. Yet another object of the present patent document is to provide a device or means that can be used to remotely alert and communicate diagnostic feedback, functional failings, and/or improper operational conditions information, to transducers, smart actuators and force transducers having IEPE designs.

To this end, in one aspect of the present patent document, a transducer assembly is provided. In a preferred embodiment the transducer assembly comprises a transducer and a wireless indicator that can read from the TEDS data sheet and transmit data wirelessly that has been directly read from the TEDS data sheet. In such an embodiment, a wireless chip on the transducer side may be listening for a command from the reader/writer. In some embodiments, custom protocols may be designed to facilitate the transducer side listening for a command. In other embodiments, well known protocols may be used. In still other embodiments, a combination of custom and well known protocols may be employed.

In operation, a wireless reader/writer may transmit a read command to a transducer. The command is received by a wireless chip added proximate to the transducer and then sent from there to a microprocessor. Once the microprocessor of the transducer receives the read command, the microprocessor may act on the command. In preferred embodiments, the microprocessor may have direct access to a TEDS datasheet. To this end, the microprocessor may read information from the TEDS datasheet, which is stored in non-volatile memory. The microprocessor may then send the information to the wireless chip to transmit that information to the reader/writer.

In some embodiments, the wireless chip may be a near-field communication (NFC) chip. The NFC chip serves to communicate information back and forth between the reader/writer and the transducer. In the case of a write, each value to be written to the TEDS datasheet will be received via the wireless interface, communicated to the microprocessor via internal serial interface and then written to non-volatile memory. The internal interface between the wireless chip and the microprocessor may be any type of interface. Typically, a serial interface or serial bus may be used. However, in other embodiments, other interfaces may be used. In preferred embodiments, the internal interface may be an I2C or SPI interface.

In another preferred embodiment, for certain transducers that do not have a TEDS chip included within the transducer assembly or transducer housing, a TEDS chip could be included within this invention such that transducer cable assembly would include a TEDS chip in combination with a wireless chip and a microprocessor. This would be of particular benefit to transducers that do not, or cannot have, a TEDS chip installed within the transducer assembly or transducer housing. Instead, these non-TEDS transducers may have an integral (non-removable) cable that embeds the TEDS chip within the integral (non-removable) cable assembly. A similar embodiment could also be used with transducers that have cable connectors that accommodate removable cables.

In preferred embodiments, the transducer assembly further includes an indicator electrically connected inline with the transducer. In an even more preferred embodiment, the sensor is electrically connected with only two wires. In yet an even more preferred embodiment, the transducer is an Integral Electronic Piezo Electric (IEPE) sensor. In some embodiments, the indicator is in electrical communication with the microprocessor.

Although in different embodiments different types of indicators may be used, in a preferred embodiment the indicator is a light. In a more preferred embodiment, the indicator is a light-emitting diode (LED). In some embodiments, the light-emitting diode is an infrared light-emitting diode.

In operation of a preferred embodiment, the indicator is turned on and off in parallel with a digital or signaling protocol. In a preferred embodiment, the indicator is turned on and off in parallel with the use of a smart transducer interface module (STIM). In an even more preferred embodiment, the indicator is turned on and off in parallel with a Transducer Electronic Data Sheet (TEDS) request. TEDS is a standardized method of storing transducer (transducers or actuators) identification, calibration, correction data, and manufacturer-related information. TEDS is a data structure stored in a small amount of nonvolatile memory, physically associated with the transducer. The TEDS is used to store parameters which describe the transducer to the network capable application processor (NCAP), making self-identification of the transducer to a system possible. TEDS formats are defined in the IEEE 1451 set of Smart transducer interface standards developed by the IEEE. All of the aforementioned information included in the defined TEDS format can be transmitted by the wireless chip, however, this invention does not limit data strictly to the TEDS standard formats because additional information can also be transmitted, such as physical location, GPS or LPS positioning information or other data that could also be stored in TEDS formats developed in the future.

In some embodiments, the sensor assembly comprises one or more diodes to electrically isolate the indicator when the transducer is in use. In some of those embodiments, the diodes are arranged to allow current to the indicator when a direction of current is reversed from a direction of current used to operate the sensor. In some embodiments, the diode(s) is/are in electrical communication with both the sensor and the microprocessor and oriented to prevent current flow to the microprocessor when current is flowing to the sensor and to prevent current flow to the sensor when current is flowing to the microprocessor.

In some embodiments, a mobile device may be used to wirelessly communicate status data from the transducer assembly. TEDS data may be accessed with the ability to read and write from an associated wireless transmitter or hand held device (HHD), including Global Positioning System (GPS) coordinates and IEPE transducer bias voltage. In the case of GPS coordinates, these could be written and stored directly into the TEDs chip from the HHD. In other embodiments, the GPS coordinates could also be written and stored in the HHD or written and stored directly into the data acquisition system or computer system that is interfaced with the sensor. Also, the GPS system and GPS data could also be substituted for and LPS (local positioning system) for more accurate positioning coordinates.

In a preferred embodiment, the HHD is capable of pulsing the LED indicator to indicate the particular transducer being interrogated and/or to obtain information fields available from the TEDS transducer.

In some embodiments, the HHD may incorporate security measures such as fingerprint recognition technology for secure access and password protection. The security measures may limit access to select features as determined by some level of user authority.

In preferred embodiments, the LED/HHD will be able to read & write all TEDS formats including, but not limited to, company specific formats. The embodiments described herein are not limited to data stored in TEDS format. Data stored in any format may be transmitted by the wireless chip. The HHD may also embody an appropriate hardware connection/interface to enable read and write of TEDS information/data to any transducer, chip type and format.

In a more preferred embodiment, the transducer and HHD may communicate using Bluetooth technology and/or a USB port to share TEDS data and receive firmware updates. Yet an even more preferred embodiment has the LED/HHD system having the ability to read/decode barcodes utilized by various manufacturers of transducers.

In some embodiments, the HHD device may have the capability of charging or re-charging the power via a USB port/jack from a portable computer/laptop/tablet while in use, as well as via a wall charger device.

Another aspect of the HHD is to have the ability for the HHD to have an “app” written for it similar to an app on a smartphone. The app could be specifically written for this application of identifying the TEDS information and the location of the sensor. The app could also provide a means for the HHD to take a photograph of the sensor location and relate or connect the photograph with the TEDS data. The app could then associate the photograph with the physical location of the sensor in software in a database or other method of recording the data. The physical location of the sensor can be identified by manually inputting the location of the sensor into the sensor's TEDS chip along with a photograph of the sensor showing its location. This may be used as a primary source or secondary source of verifying the location of the sensor with no possibility of human error. The objective in providing a photograph of the sensor location tied to the TEDS data of the sensor is to provide error-proofing during test set up so that if a test engineer or a test technician makes an error during the test set up, the photo tied to the TEDS data will absolutely verify that the serial number of the sensor taken from the TEDS data is absolutely matched with the correct location. This method of error proofing will greatly lower the time of test set up and could possibly remove the need to use more expensive test engineers and instead use lower cost test technicians to conduct the test setup.

In another aspect of the present patent document, a method of visually verifying location and displaying other operational, health and/or alerting aspects of a transducer is provided. In a preferred embodiment, the method includes the steps of: providing power over a cable to a sensor with a first power supply; and switching from a first power supply to a second power supply and causing an indicator located proximal to the sensor to indicate. In preferred embodiments, a switch is configured to toggle electrical communication between a single wire and the first power supply and the second power supply.

In a preferred embodiment, the switching step causes a current within the sensor circuit to reverse directions. The method is preferably used with a sensor that is an IEPE. In some embodiments, the current switching may be controlled manually, in other embodiments, the current switching may be controlled under software or computer control.

In some embodiments, the second power supply is in electrical communication with the indicator via the cable. In a preferred embodiment the indicator is a light emitting diode (LED).

In another aspect of the present patent document an indicator assembly is provided. In a preferred embodiment, the indicator assembly comprises: a body; a first wire and a second wire in electrical communication with a first electrical connector and a second electrical connector on opposite ends of the body respectively; an indicator on the exterior of the body and in electrical communication with the first wire and the second wire; and at least one diode arranged to allow current to flow through the indicator in a single direction.

In a preferred embodiment of the indicator assembly, the first electrical connector and second electrical connector are connected to only two wires. Preferably, the indicator is designed to turn on and off in parallel with a digital or signaling protocol. In a preferred embodiment, the digital or signaling protocol is a Transducer Electronic Data Sheet.

In another aspect of the present patent document, a cable assembly is provided. A preferred embodiment of the cable assembly comprises: a cable including; a first wire and a second wire in electrical communication with an electrical connector designed to mate with a transducer; an indicator integrated into the cable and in electrical communication with the first wire and the second wire; and at least one diode arranged to allow current to flow through the indicator in a single direction.

In some embodiments, a sensor system is provided that comprises a sensor; a microprocessor; non-volatile memory in data communication with the microprocessor and containing a TEDS; and, a wireless communication chip in data communication with the microprocessor; wherein a single wire provides current to both the microprocessor and sensor.

The sensor, microprocessor, non-volatile memory and wireless communication chip may all be contained within the sensor assembly. In other embodiments, the microprocessor, non-volatile memory and wireless communication device may all be contained within a cable assembly coupled to the sensor assembly. In still yet other embodiments, the microprocessor, non-volatile memory and wireless communication chip are all contained within a retrofit indicator assembly with connectors at each end, wherein the connectors are designed to connect a cable assembly to a sensor assembly.

In another embodiment, a method of verifying a transducer is provided. The method comprises reversing the flow of current on a wire that provides power to both a micro-processor and a transducer; listening for a read signal on a wireless communication chip; receiving a read request on the wireless communication chip; communicating the read request to a microprocessor; reading transducer data from non-volatile memory in data communication with the microprocessor; transmitting the transducer data with the wireless chip.

In preferred embodiments, the method further comprises illuminating an indicator proximate to the transducer in response to receiving the read signal. The indicator may be turned on and off in parallel with a digital or signaling protocol. In some embodiments, the transducer data includes locational information for the transducer. In some of those embodiments, the locational information is GPS data.

In some embodiments, the transducer data is transmitted to a hand held device. In some embodiments, the hand held device may be a smartphone.

In another embodiment, an assembly is provided that comprises a sensor in electrical communication with a wire; a microprocessor connected inline with the sensor using the same wire; a diode arranged to allow current flowing in one direction to power the sensor and prevent current flowing in an opposite direction from powering the sensor; an indicator in electrical communication with the microprocessor; non-volatile memory containing sensor data in electrical communication with the microprocessor; and a wireless communications chip in electrical communication with the microprocessor.

### BRIEF DESCRIPTION OF THE DRAWINGS

FIG. 1 illustrates an isometric view of one embodiment of a transducer cable assembly including a mating transducer connector and an indicator assembly with an indicator designed to indicate a status. It also shows a smartphone as an example of a way to read data from the NFC chip inside or outside of the transducer cable assembly.

FIG. 2 illustrates a schematic view of a sensor system including a sensor connected with a cable assembly including an indicator assembly and wireless connectivity.

FIG. 3 illustrates an isometric view of one embodiment of a retrofit indicator assembly designed to be retrofit to existing cables and/or sensors.

FIG. 4 illustrates an isometric view of one embodiment of a sensor assembly including an indicator built into the sensor.

FIG. 5 is a flowchart that illustrates a method for verifying an indicator that provides visual feedback and/or data feedback for a camera system, human, etc. It also includes an example of a method of reading and writing data to and from the sensor or to the data acquisition system via a NFC (near field communication) chip that is an integral part of the transducer cable assembly.

### DETAILED DESCRIPTION OF THE PREFERRED EMBODIMENTS

The terms “computer-readable storage medium” and “computer-readable storage media,” as used herein, refer to a medium or media that participates in providing instructions to a CPU for execution. Such media may take many forms that include, but are not limited to, non-volatile and volatile media. Non-volatile media include optical or magnetic disks, such as fixed disks. Volatile media include dynamic memory, such as system RAM. Common forms of computer-readable storage media include, for example, floppy disks, flexible disks, hard disks, magnetic tape, any other magnetic media, CD-ROM disks, digital video disks (DVDs), any other optical media, punch cards, paper tape, any other physical media with patterns of marks or holes, RAM, PROM, EPROM, FLASHEPROM, and any other memory chip or cartridge.

Solutions to the complex problem of correctly wiring and wiring verification on a large test facility are provided in U.S. Patent Application Publication No.: 2014-0210631 (hereinafter “'631 Publication”), which is herein incorporate by reference in its entirety. The present patent document provides for wireless capability to be embedded in or on a transducer, or in or on a cable near the transducer. The preferred embodiments allow data to be read or written to and from the transducer and read and written to and from the equipment sensing the signal, such that the execution of the read and write process takes place at or very near the transducer. A wireless process for inputting data such as physical location at or near the sensor location will reduce manpower, reduce time and also reduce errors associated with current methods. The embodiments and methods taught herein may eliminate the need for a cable to be disconnected and a separate device be connected.

As used herein, when referring to the location of a structural element, the term “near the transducer” means as part of the transducer assembly itself or on the transducer end of a cable assembly connected to the transducer assembly. The use of the term “near the transducer” with respect to structural elements like an LED is intended to define a location that is close enough to the transducer to allow one viewing the structural element to determine the transducer the structural element is associated with. When referencing the location of a hand held device or other equipment being used by a user, the term “at or near the transducer” means in the general vicinity of the transducer within the larger assembly the transducer is attached to. In preferred embodiments that use an LED or another light source, a capacitor may be incorporated with the LED. The incorporated capacitor can be used to: 1.) increase the brightness of the LED; 2.) accentuate the LED; or 3.) allow the operator to vary the brightness of the LED. The varying brightness may be used as a form of communication to the operator. For example, low brightness could indicate a normal state of the transducer and high brightness could indicate an abnormal state of the transducer. In some embodiments, different colors may be used as a preference by the operator or different colors may be used to indicate different information to the operator such as a normal state or an abnormal state or other information. A combination of different colors and different levels of brightness can also be used within the LED.

The apparatus and methods of the present patent document incorporate a microprocessor and a near field communication (NFC) or radio-frequency identification (RFID) or other type of wireless chip into the transducer assembly or transducer cable. In some embodiments, more than one wireless device may be used. For example, some embodiments may have both an RFID in addition to WiFi such as IEEE 802.11 or other wireless chip. As used herein, a wireless chip means any electronic device that provides wireless communication capabilities. In preferred embodiments, the wireless chip may be incorporated into an embodiment of the '631 Application that includes an indicator such as a LED.

The addition of wireless capability allows the LED product to have data read out of it when interrogated by another wireless sensor reader. One purpose of this functionality is to enable test and measurement customers to match the serial number, or other data, of a sensor to the physical location of the sensor on a physical unit under test. For example, when vibration testing a satellite, the user of the reader/writer may input the physical location of the sensor into the reader/writer. The physical location may then be transmitted—wirelessly or via wire—back to the data acquisition system/computer system and/or the sensor. To this end, the entire system is provided the data on the physical location of the sensor that ties to the serial number, or other data, for each specific sensor on the system network.

Once the transducers are wired up, the operator performs a TEDS read function from the data acquisition (DAQ) system for all transducers so that all serial numbers could be populated within the DAQ system database. Once the database is populated, then all of the serial numbers and other data may be written from the transducer into an RFID via the microprocessor. After the RFID is populated with the data, then when the handheld channel reader gets in close proximity, the RFID transmits the data to the handheld device. Receiving this serial number information causes a message and the serial number to be transmitted from the handheld device to the DAQ system. When the DAQ system receives the data from the handheld device, the DAQ system can switch the power supply and “wake up” the sensor by putting that channel into TEDS mode, thereby causing the LED to flash.

In preferred embodiments, the data transmitted by the wireless chip may be used to match the serial number description to the physical location description within a database.

In preferred embodiments, the wireless chip will be implemented in conjunction with an indicator such as an LED. The addition of the LED helps the user of the system to further verify that the data he is receiving wirelessly is in fact from the transducer he thinks it is. In a preferred embodiment, the LED may be activated by a GPIO pin on a microprocessor located within the cable transducer assembly. In some embodiments, the LED is able to be activated by a command sent from the reader/writer to the transducer after which the microprocessor will turn on the LED. In other embodiments, the LED may be activated automatically anytime the microprocessor is performing a read/write command. In such embodiments, the LED may indicate when a particular transducer is wirelessly transmitting data. In other embodiments, the LED may indicate upon other events.

One advantage of adding the wireless capability to the LED indicator is that the wireless system can read and transmit the serial number and other relevant data, such as the sensor sensitivity, directly from within the internal TEDS (Transducer electronic data sheet) chip, or a similar chip, inside of the sensor that is attached to it. By directly reading the data, any sort of human error, such as putting the wrong bar code sticker on the wrong sensor or having a smeared barcode sticker or just mistyping, is prevented from occurring.

In a preferred embodiment, the wireless communicating sensor with LED may use commercially available wireless chips. Numerous different types of wireless chips and protocols may be used including NFC, RFID, Bluetooth, IEEE 802.11 or any other type of wireless chip. In some embodiments, the wireless capability may be incorporated on the same chip as the microprocessor.

In different embodiments, various different types of readers may be used, including a dedicated product or even some of the newer phones or hand held devices which are incorporating NFC technology.

In some embodiments, location detection technology may be incorporated. Location detection capability may allow a user to determine the approximate location of the device. This would allow the user to find the location of a cable within a large area faster. The embodiments described here may prevent human error when customers collect test results but also may save a tremendous amount of time to customers conducting large channel count tests that have many sensors in use.

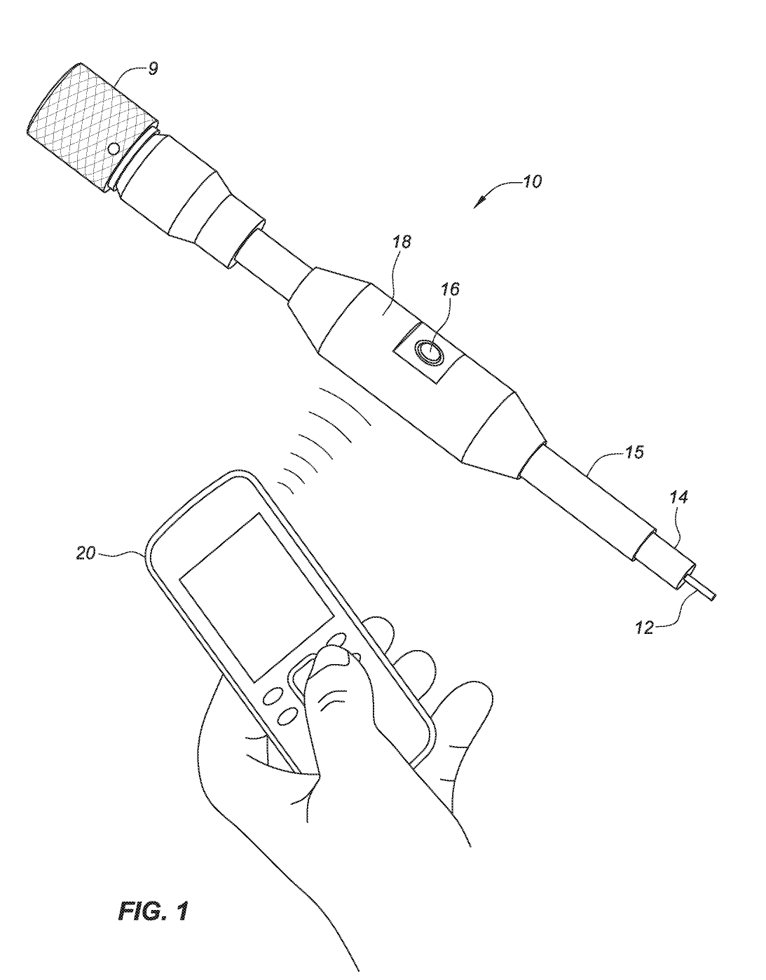

FIG. 1 illustrates an isometric view of one embodiment of a transducer cable assembly 10 including a mating transducer connector 9 and an indicator assembly 18 with an indicator 16 designed to indicate a status. Indicator assembly 18 is coupled to cable 15. Cable 15 includes wires 12 and 14. The cable assembly 10 may be connected to any type of sensor via the mating transducer connector 9. The sensor (not shown) may be designed to measure dynamic pressure, force, strain, acceleration or any other physical phenomena. In a preferred embodiment, the cable assembly 10 has an electrical configuration compatible with an IEPE sensor. However, in other embodiments, the cable assembly 10 may have any other type of electrical configuration. In some embodiments, the cable assembly 10 may be configured to be compatible with a Piezoelectric (“PE”) transducer or any other type of transducer.

In the embodiment shown in FIG. 1, the transducer assembly 10 has one or more indicators 16 embedded within the indicator assembly 18. In the embodiment shown in FIG. 1, the indicator 16 is an LED. However, in other embodiments, the indicator 16 may be any type of indicator including, a light, thermally sensitive material, switch acoustic actuator or any other type of component that can convey a status, binary or otherwise.

In use, cable assembly 10 is coupled to a transducer. The indicator 16 is toggled to display the status of the transducer mated to cable assembly 10. The status being displayed may be any type of status, including but not limited to the status of: a proper power connection, data connection, functioning transducer, cable integrity, circuitry health, transducer calibration, interconnection verification, end identification and/or position locating, diagnostic feedback, or any other type of status. To this end, more than one indicator 16 may be used. In the preferred embodiment, the indicator 16 is a binary indicator such as a light that is on or off. However, other more sophisticated indication schemes may be used to allow a single indicator 16 to display multiple statuses. As just one non-limiting example, the indicator 16 could blink with different frequencies or different colors or use multiple indicators to indicate different conditions. If multiple indicators 16 are used, each indicator 16 could individually display a binary status. In other embodiments, patterns of binary indicators may be used to display even more complicated statuses.

In a preferred embodiment, cable assemblies 10 including the indicator assembly 18 allow a user to cause the indicator 16 to indicate on command. As one example to demonstrate the point, assume there is an engine under test with multiple transducers assemblies located at different locations throughout the engine. Each transducer is connected with a cable assembly 10 that includes an indicator assembly 18 using an LED as an indicator 16. All of the transducers are wired back through cable assemblies 10 to a transducer instrument designed to acquire and determine the output of each transducer. Assume during the test the user sees an anomalous value being read out on the transducer instrument and that anomalous value shows the problem is associated with the transducer attached to channel 7. Assume this particular transducer is supposed to be the transducer attached to the turbo pump. Given this example, in the old systems, the user would have no easy way to verify that the system was actually wired up and configured correctly so that the user could be assured that the anomalous value being indicated at the transducer instrument was actually coming from the transducer physically attached to the turbo pump.

In the embodiments of the present patent document, a user can instruct the LED indicator 16 associated with channel 7 to blink or turn on. In a preferred embodiment, this is done via software. The system then sends a signal over the wires associated with channel 7 that would cause the LED to blink. If the user visually sees the LED on the cable assembly 10 attached to the transducer on the turbo pump blink or turn on, the user can be assured that the anomalous reading is coming from that particular transducer and everything is wired correctly. To this end, the embodiments of the cable assembly 10 with indicator assembly 18 provide an end-to-end verification of the correct wiring and placement of a multitude of transducers assemblies in a multi-transducer system.

In a preferred embodiment, the indicator assembly 18 including the indicator 16 is wired “inline” with the transducer. In the context of this specification, “inline” means that the same wires used to receive the signal from the transducer and power the transducer are used to provide power to the indicator 16. “Inline” does not require that the indicator 16 be wired in parallel or series but only rather that the same wires used to operate the transducer are also used to provide power to the indicator 16 without additional wiring. Wiring the indicator 16 inline has a number of advantages to using additional wires. One advantage is that no additional wiring or modifications are needed to existing transducers. Another advantage is that by using the exact same wires the signal is received on, the correct wiring can actually be verified. If additional wiring is used, additional errors may exist in the wiring of the indicators, which would circumvent the verification process.

In a preferred embodiment like the one shown in FIG. 1, the HHD 20 is shown as a smartphone with NFC read/write capability. However, element 20 could be any sort of NFC or other type of wireless read/write device. Within the housing 18, the NFC chip (or similar wireless device) is located that is communicating to the handheld wireless reader/writer (HHD), such as a cell phone 20. The HHD may contain GPS or LPS system functionality that could write GPS or LPS coordinates to the NFC chip and then write the coordinates to the TEDS chip, or another volatile memory location. Additionally, the GPS or LPS device could be located within the transducer cable assembly. The NFC in housing 18 is also communicating with the sensor TEDs chip or similar type of data storing chip and also with the computer or data acquisition system. The wireless chip for both the reader/writer and also on the transducer side would be connected to a microprocessor with communication via a standard serial interface such as SPI or I2C.

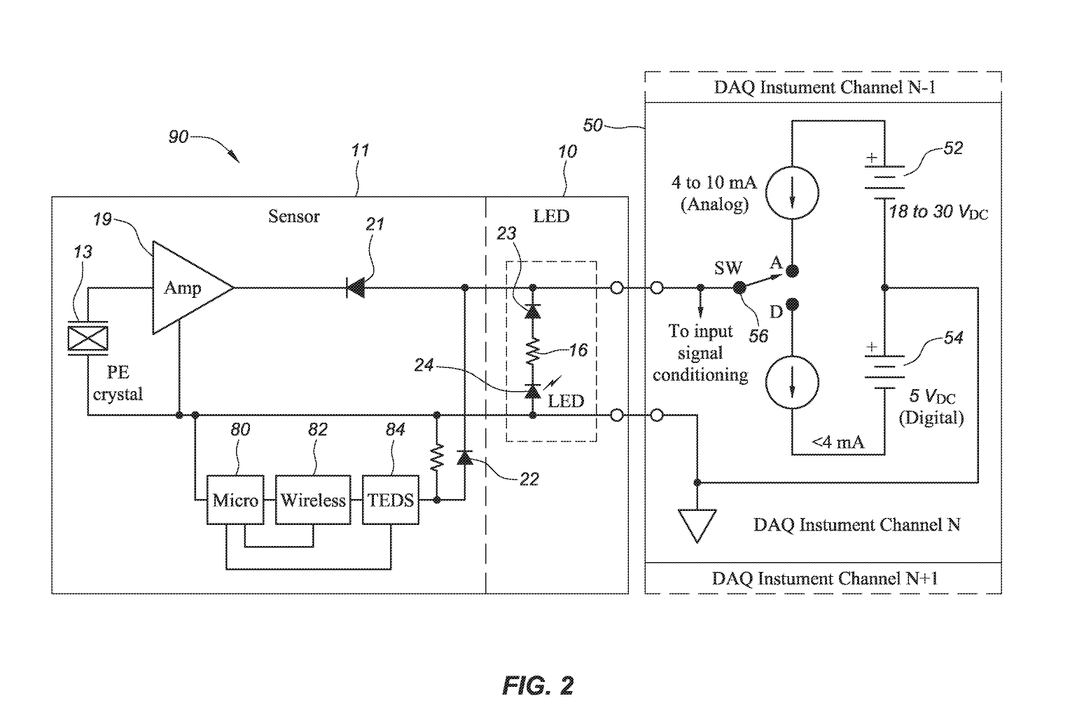

FIG. 2 illustrates a schematic view of a sensor system 90 including a sensor assembly 11 connected with a cable assembly 10 including an indicator assembly 18. In the preferred embodiment shown in FIG. 2, the indicator assembly 18 is wired inline with the sensor assembly 11. While systems may be used with additional wires for the indicator assembly 18, inline wiring is preferred.

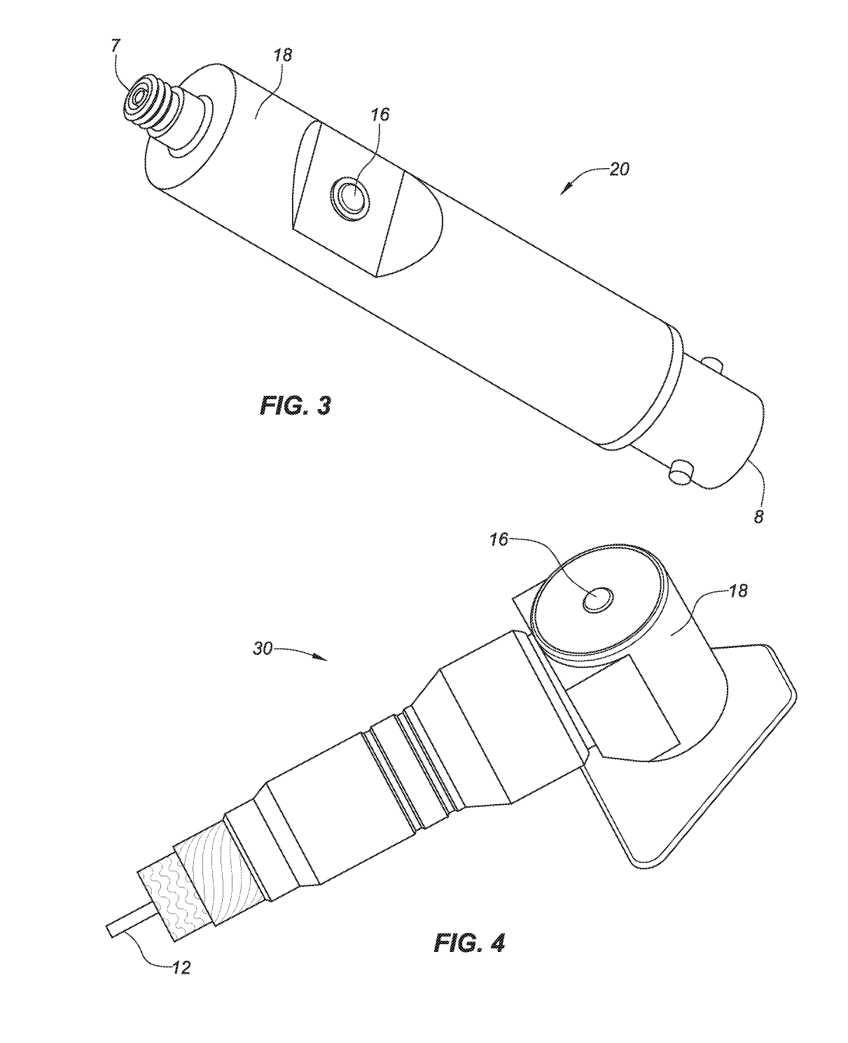

As may be seen in FIG. 2 and as used herein, the term “sensor system 10” refers to the sensor assembly 11 and the indicator assembly 18. As shown in FIGS. 1 and 2, the indicator assembly 18 may be provided as part of a cable assembly. However, in other embodiments, other configurations are possible. As shown in FIG. 3, the indicator assembly 18 may be designed so that it can be retrofit into existing systems. FIG. 3 illustrates an isometric view of a retrofit indicator assembly 20. Retrofit indicator assembly 20 includes an indicator assembly 18 and two cable adapters 7 and 8. Accordingly, retrofit indicator assembly 20 may be connected inline between the sensor and the cable designed to connect to the sensor. To this end, the functionality of the indicator assembly 18 may be adapted to existing sensors and existing sensor systems. A preferred embodiment of the retrofit indicator assembly 20 supports two-wire, IEPE physical test infrastructures and enables a controllable on/off indication at a remote location of the IEPE.

FIG. 4 illustrates an isometric view of one embodiment of a sensor assembly 30 including an indicator 16 built into the sensor assembly 30. The embodiment shown in FIG. 4 may be a custom built sensor with indicator 16. The embodiment shown in FIG. 4 may have the same electrical configurations as the embodiments of the form shown in FIG. 2; however, the indicator assembly 18 is physically built into the sensor assembly 30 instead of the cable assembly. One advantage of the embodiment shown in FIG. 4 is that the indicator assembly 18 may be placed closer to the sensor head rather than proximal but down on the cable.

Returning to FIG. 2, it may be seen that in addition to the inline wiring of an indicator assembly 18, a microprocessor 80, wireless chip 82 and non-volatile memory 84 are also wired inline with the sensor 13. In the embodiment shown in FIG. 2, the microprocessor 80, wireless chip 82 and non-volatile memory 84 are part of the of the sensor assembly 11. However, in other embodiments, the microprocessor 80, wireless chip 82 and non-volatile memory 84 may be located in other places just like the indicator assembly 18. Accordingly, the microprocessor 80, wireless chip 82 and non-volatile memory 84 may be located in the other locations such as the indicator assembly 20 (See FIG. 2), or the cable assembly 10 (See FIG. 1). The indicator 16 may or may not be co-located with the microprocessor 80, wireless chip 82 and non-volatile memory 84.

In some embodiments, the microprocessor may be wired inline with the sensor 13 and the indicator 16 may be controlled by the microprocessor rather than also being wired inline. The indicator wired to the microprocessor may be the only indicator or may be in addition to the indicator 16 wired inline with the sensor 13. Moreover, more than one indicator may be wired in either configuration or any combination thereof.

In systems with inline wiring, a switching mechanism is needed to allow power to be toggled to the indicator 16 and/or the microprocessor 82 over the same wires that typically carry the sensor signals. In the embodiment shown in FIG. 2, this is achieved using switch 56. Switch 56 toggles between two different power sources 52 and 54, one with a positive voltage 52 and one with a negative voltage 54. When switch 56 (SW1) toggles between position A and position D, the flow of current throughout the sensor 13 and cable assembly 10 is reversed. The placement of diodes 21, 22, and 23 prevent current flow to the sensor electronics and cause the LED indicator 16 to light up along with powering the microprocessor 80.

The electrical configuration shown in FIG. 2 is only one embodiment of many for wiring an indicator 16 inline. In other embodiments, other inline wiring may be used. The embodiment illustrated in FIG. 2 was chosen because it illustrates the typical already existing wiring of an IEPE sensor that includes Transducer Electronic Data Sheet (“TEDS”). Systems designed to support IEPE sensors with TEDS already include diode 21 and 22 and switch 56 along with power supplies 52 and 54. To this end, an IEPE system with TEDS may be adapted to an embodiment of the present patent document by adding indicator assembly 18 along with wireless chip 82. Indicator assembly 18 may be built into a cable assembly 10, built into the sensor itself or provided inline with an adapter. A TEDS sensor and/or actuator are/is not required to take advantage of this inline indicator implementation.

To this end, the voltages and currents along with digital and analog markings of the embodiment shown in FIG. 2 are typical of an IEPE system with TEDS. However, in other embodiments other voltages and currents may be used. In addition, the indicator assembly 18 may be implemented as either an analog or digital system. The type and design of the power supplies used may drive the type of indicator 16 that may be used. In systems like the one shown in FIG. 2, where current is low, indicators 16 that work with low current such as LEDs are preferred. However, in other embodiments, other power sources may be used and different types of indicators 16 may be used.

In the embodiment shown in FIG. 2, the indicator 16 is wired to be a simple binary on/off indicator 16. However, in other embodiments, switch 56 may be more advanced and allow more advanced methods of indication. For example, if the switch 56 is a three position switch, the switch 56 may be toggled to cause indicator 16 to blink or even blink with different frequencies such that a more sophisticated signaling is enabled.

As mentioned already, in some embodiments, rather than being wired in parallel with a control protocol such as a TEDS system, the indicator assembly 18 may be wired in series with the control protocol and be controlled by a microprocessor 80 within the system. To this end, the microprocessor 80, which would receive the power when switch 56 was toggled into position D, would then control the indicator 16. Such control may be sophisticated such that the indicator 16 could blink at any number of frequencies or turn on or off. In addition, more than one indicator 16 may be used.

Digital processing allows much more intricate control and allows indicator assembly 18 to be more versatile. As just one example, the indicator 16 may be toggled on or off in parallel with the acquisition of a digital or signaling protocol. This provides visible and verifiable location readout and diagnostic feedback without impacting the performance of the IEPE sensor. In a preferred embodiment, the digital or signaling protocol is Transducer Electronic Data Sheet (“TEDS”) data. However, in other embodiments, other digital signaling protocols may be used.

As shown in FIG. 2, in a preferred embodiment, the indicator assembly 18 is designed to work with an IEPE sensor. In such embodiments, the sensor assembly 11 contains a sensing element 13 made of a PE material that converts mechanical strain into an electrical signal, and an electronic circuit 19 to amplify the electrical signal and transmit it to an external recording device 50 (DAQ Instrument). The built-in electronics in the amplifier 19 convert a high-impedance charge signal that is generated by the PE sensing element 13 into a usable low-impedance voltage signal that can be transmitted over ordinary two-wire or coaxial cables 15 to any voltage readout or recording device. The low-impedance signal can be transmitted through long cables and used in dirty field or factory environments with little degradation. In addition to providing crucial impedance conversion, IEPE sensor circuitry can also include other signal conditioning features, such as gain, filtering, and self-testing.

The electronics within the sensor assembly 11 require excitation power from a constant-current regulated, direct current (“DC”) voltage source. A separate signal conditioner can be provided when none is built into the readout. In addition to providing the required excitation, power supplies may also incorporate additional signal conditioning, such as gain, filtering, buffering, and overload indication.

Although in a preferred embodiment indicator assembly 18 is used to verify the wiring of a sensor assembly 11, indicator assembly 18 may indicate any number of sensor statuses. In one embodiment of the present patent document, the status indicating assembly 18 is designed to verify the interconnection between an amplifier 19 and its associated sensor 13. This may be especially important if the sensor is not an IEPE sensor where the amplifier 19 is built in.

The IEPE sensor may be used in numerous different arenas. Use and maintenance of a sensor usually requires conducting a performance analysis and fault diagnosis of the working status and the interconnecting circuits of the sensor. As discusses above, the embodiments of the present patent document help alleviate some of the numerous problems associated with conducting such a performance analysis and fault diagnosis and verification by allowing the tester to be collocated near the sensor and allowing the sensor to directly read sensor information from the non-volatile memory and transmit it wirelessly.

This patent document is not limited to the TEDS protocol; any type of digital signal or control signaling may be used, but TEDS is a working example. In a preferred embodiment of the present patent document. TEDS stores the IEPE identification, calibration, and correction data, and manufacturer-related information. In another preferred embodiment, TEDS is implemented as a memory device attached to the transducer and containing the information needed by a measurement instrument or control system to interface with a transducer. TEDS can reside in embedded memory within the transducer itself, which is connected to the IEPE sensor. The embedded memory is typically an EEPROM.

In a preferred embodiment, if the indicator is wired in parallel with another system such as TEDS, the indicator should use sufficiently low current to not hinder the operation of the sensor system. In a preferred embodiment where the indicator 16 is wired in parallel with a TEDS system, a low current LED is used. A low current LED allows the TEDS to work normally when required. In a preferred embodiment, the packaging and location of the LED is selected to provide the greatest angle of overall visibility.

In one embodiment, the host's TEDS application software may be changed to control the pattern of when the LED 16 turns on or off. As a non-limiting example, the LED current may be continuous. As another non-limiting example, the LED 16 may blink slowly, such as at 0.2 to 2.0 Hz, to facilitate easy human visual detection.

The embodiments of the present patent document may provide interconnection verification at a lower cost when used for validating large channel count setups. In particular, the embodiments disclosed herein provide for easier location, identification, and replacement of a specific IEPE sensor, particularly in a large, multi-channel configuration with a cable adaptor with IEPE sensors.

In some embodiments, especially those where the indicator 16 is wired to a controller such as a TEDS controller (Network Capable Applications Processor—NCAP), the indicator 16 may be used as a diagnostic tool if the indicator 16 is programmed to light up or flash at different frequencies, depending on whether a certain condition is present. The condition could be a problem condition, such as failed wiring or a faulty sensor or cable. As a non-limiting example, the indicator 16 may light up if the sensor is accelerated faster than a threshold level of acceleration. This may indicate to the test technician that the sensor range for acceleration is too low and needs to be increased. In other embodiments, other conditions may be indicated.

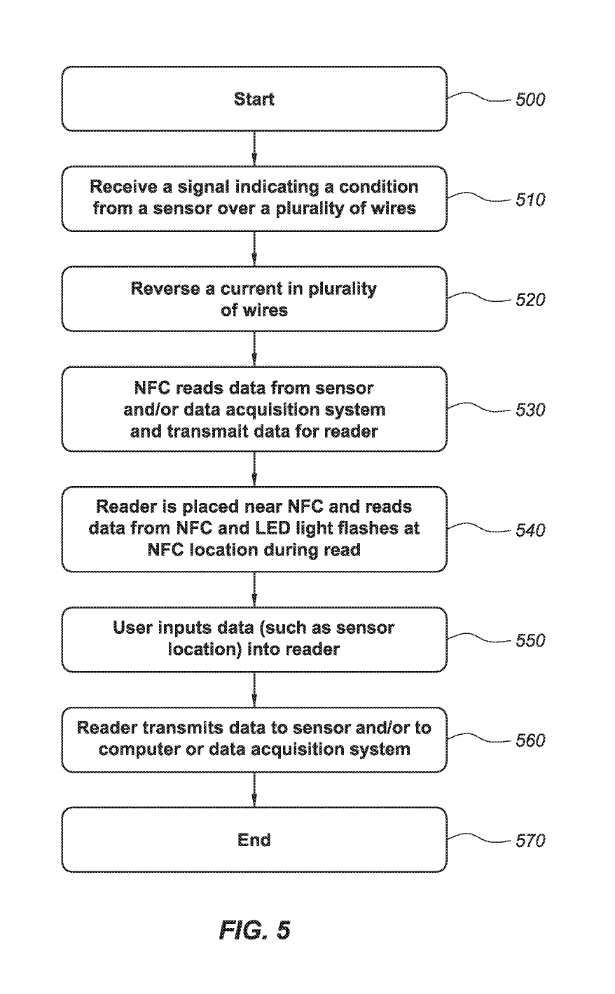

FIG. 5 is a flowchart that illustrates a method for verifying an LED indicator that provides visual feedback and for reading and writing data to and from the NFC chip as well as to and from the sensor and data acquisition system. The steps and order of steps identified in FIG. 2 are exemplary and may include various alternatives, equivalents, or derivations thereof. Intervening steps may be possible in other embodiments. The steps of the method of FIG. 2 and its various alternatives may be embodied in hardware or software, such as a computer-readable storage medium (e.g., optical disc, memory card, etc.) comprising instructions executable by a processor of a computing device.

In the method 500, step 510 is receiving a signal indicating a condition from a transducer over a plurality of wires. In a preferred embodiment, the signal is sent from a wired transducer and received by a transducer interface. In embodiments where a wired transducer is capable only of detecting one type of condition, the type of transducer and the condition it detects may have been previously identified or provided to the transducer interface.

Step 520 reverses current in the plurality of wires. Step 530 is when the NFC reads data from the sensor or the computer or data acquisition system, or both and prepares the data to be transmitted to a reader. Step 540 shows that the reader is in contact with the NFC chip thereby causing the LED to indicate that the NFC is active and that data will be transmitted between the reader and the NFC. Step 550 provides for the user of the reader to input data into the reader, such as sensor location information or other information. Step 560 allows for the reader to transmit the data to the sensor and/or to the data acquisition system.

One use of the embodiment shown in FIG. 2 is to enable test and measurement customers to match the serial number of a sensor to the physical location of the sensor on a physical unit under test, such as a satellite during a laboratory vibration test. The data contained within the “wireless readable/writable LED” will be used to match the serial number description to the physical location description within a database.

Although the inventions have been described with reference to preferred embodiments and specific examples, it will readily be appreciated by those skilled in the art that many modifications and adaptations of the methods and devices described herein are possible without departure from the spirit and scope of the inventions as claimed hereinafter. Thus, it is to be clearly understood that this description is made only by way of example and not as a limitation on the scope of the invention.

What is claimed is:

1. A sensor system comprising:
a sensor;
a microprocessor;
non-volatile memory in data communication with the microprocessor and containing a TEDS; and,
a wireless communication chip in data communication with the microprocessor;
wherein a single wire provides current to both the microprocessor and sensor.

2. The sensor system of claim 1, wherein the sensor, microprocessor, non-volatile memory and wireless communication chip are all contained within the sensor assembly.

3. The sensor system of claim 1, wherein the microprocessor, non-volatile memory and wireless communication device are all contained within a cable assembly coupled to the sensor assembly.

4. The sensor system of claim 1, wherein the microprocessor, non-volatile memory and wireless communication chip are all contained within a retrofit indicator assembly with connectors at each end, wherein the connectors are designed to connect a cable assembly to a sensor assembly.

5. The sensor system of claim 1 further comprising a diode in electrical communication with both the sensor and the microprocessor and oriented to prevent current flow to the microprocessor when current is flowing to the sensor and to prevent current flow to the sensor when current is flowing to the microprocessor.

6. The sensor system of claim 1, further comprising an indicator in electrical communication with the microprocessor.

7. The sensor system of claim 1, wherein the sensor is an IEPE transducer.

8. The sensor system of claim 1 further comprising a first power supply, a second power supply and a switch, wherein the switch is configured to toggle electrical communication between the single wire and the first power supply and the second power supply.

9. The sensor system of claim 1, further comprising an indicator that is wired inline with the sensor.

10. The sensor system of claim 6, wherein the indicator is a LED.

11. A method of verifying a transducer comprising:
reversing the flow of current on a wire that provides power to both a micro-processor and a transducer;
listening for a read signal on a wireless communication chip;
receiving a read request on the wireless communication chip;
communicating the read request to a microprocessor;
reading transducer data from non-volatile memory in data communication with the microprocessor;
transmitting the transducer data with the wireless chip.

12. The method of claim 11, further comprising the step of illuminating an indicator proximate to the transducer in response to receiving the read signal.

13. The method of claim 12, wherein the indicator is turned on and off in parallel with a digital or signaling protocol.

14. The method of claim 11, wherein the transducer data includes locational information for the transducer.

15. The method of claim 14, wherein the locational information is GPS data.

16. The method of claim 11, wherein the transducer data is transmitted to a hand held device.

17. The method of claim 11, wherein the current flow is reversed by switching power from a first power supply with a positive voltage to a second power supply with a negative voltage.

18. The method of claim 16, wherein the hand held device is a smartphone.

19. An assembly comprising:
a sensor in electrical communication with a wire;
a microprocessor connected inline with the sensor using the same wire;
a diode arranged to allow current flowing in one direction to power the sensor and prevent current flowing in an opposite direction from powering the sensor;
an indicator in electrical communication with the microprocessor,
non-volatile memory containing sensor data in electrical communication with the microprocessor; and
a wireless communications chip in electrical communication with the microprocessor.

20. The assembly of claim 19, wherein the sensor data is a TEDS.

21. The assembly of claim 19, wherein the microprocessor, non-volatile memory and wireless communication chip are all contained within a cable assembly coupled to a sensor assembly.
